(19) United States
(12) Patent Application Publication
(10) Pub. No.: US 2026/0343167 A1
(43) Pub. Date: Oct. 29, 2026

(54) SIGNAL GENERATION METHOD, DEVICE, READABLE STORAGE MEDIUM, AND COMPUTER PROGRAM PRODUCT

(71) Applicant: GOERTEK INC., Weifang (CN)

(72) Inventors: Jianhua LI, Weifang (CN); Jie HUANG, Weifang (CN)

(21) Appl. No.: 19/698,996

(22) Filed: Jun. 5, 2026

Related U.S. Application Data
(63) Continuation of application No. PCT/CN2025/107829, filed on Jul. 10, 2025.

(30) Foreign Application Priority Data
Oct. 16, 2024 (CN) 202411450251.X

(51) Int. Cl. H04S 7/00; H04R 3/00

(52) U.S. Cl. CPC H04S 7/302; H04R 3/005

(57) ABSTRACT

A signal generation method, applied to an audio device including an omnidirectional microphone and a figure-eight directional microphone, includes: obtaining an original audio signal, the original audio signal includes a first audio signal and a second audio signal, the first audio signal is an audio signal collected by the omnidirectional microphone, and the second audio signal is an audio signal collected by the figure-eight directional microphone; performing channel separation processing on the original audio signal to obtain a two-channel signal, the two-channel signal includes a left channel signal and a right channel signal; and calculating, based on the two-channel signal, sound source parameters corresponding to a sound source, and rendering the original audio signal according to the sound source parameters to obtain a generated target audio signal, the sound source parameters include at least one of a sound source orientation and a sound source size.

### CROSS-REFERENCE TO RELATED APPLICATIONS

This application is a continuation application of International Application No. PCT/CN2025/107829, filed on Jul. 10, 2025, which claims priority to Chinese Patent Application No. 202411450251.X, filed on Oct. 16, 2024. The disclosures of the above-mentioned applications are incorporated herein by reference in their entireties.

### TECHNICAL FIELD

The present application relates to the technical field of signal processing, and in particular to a signal generation method, a device, a readable storage medium, and a computer program product.

### BACKGROUND

Basic characteristics of sound comprise pitch, timbre, intensity, and the like. Stereo (also referred to as 3D stereo) refers to sound that, in addition to the basic characteristics, further has spatial sense characteristics such as directionality, distance perception, and layering. For example, in a concert hall, each musical instrument has its own position, and a listener can determine a direction and a distance of a sound source based on a heard sound, which reflects directionality and distance perception of stereo.

Conventional stereo recording generally requires two microphones or more than two microphones for recording, and during recording, a distance between the two microphones needs to be relatively large (generally 2 to 3 meters are required), so as to obtain a stereo recording with relatively obvious left-right separation. Generally, stereo recording can only be performed by using an audio device having a relatively large size, and for an audio device having a relatively small size and requiring microphones to be closely integrated, such as a mobile phone, a tablet, virtual reality (VR) glasses, augmented reality (AR) glasses, and the like, due to a small distance between microphones, a recording effect may be similar to that of a single microphone, lacking a sense of stereo, and universality of stereo recording is low.

Therefore, how to improve universality of stereo recording is a technical problem that needs to be urgently solved in this technical field.

### SUMMARY

A main objective of the present application is to provide a signal generation method, a device, a readable storage medium, and a computer program product, so as to solve a technical problem of how to improve universality of stereo recording.

In order to achieve the above objective, the present application provides a signal generation method, applied to an audio device, the audio device includes an omnidirectional microphone and a figure-eight directional microphone, and the signal generation method includes the following steps:
obtaining an original audio signal, the original audio signal includes a first audio signal and a second audio signal, the first audio signal is an audio signal collected by the omnidirectional microphone, and the second audio signal is an audio signal collected by the figure-eight directional microphone;
performing channel separation processing on the original audio signal to obtain a two-channel signal, the two-channel signal includes a left channel signal and a right channel signal; and
calculating, based on the two-channel signal, sound source parameters corresponding to a sound source, and rendering the original audio signal according to the sound source parameters to obtain a generated target audio signal, the sound source parameters include at least one of a sound source orientation and a sound source size.

In an embodiment, the performing channel separation processing on the original audio signal to obtain the two-channel signal includes:
performing alignment processing on the first audio signal and the second audio signal to obtain an aligned audio signal, the alignment processing includes at least one of time alignment processing and frequency response alignment processing, the aligned audio signal includes a third audio signal and a fourth audio signal, the third audio signal is the first audio signal after alignment processing, and the fourth audio signal is the second audio signal after alignment processing;
obtaining the left channel signal by adding the third audio signal and the fourth audio signal, and obtaining the right channel signal by subtracting a phase-inverted fourth audio signal from the third audio signal; and
determining the left channel signal and the right channel signal as the two-channel signal.

In an embodiment, after the aligning the first audio signal and the second audio signal to obtain the aligned audio signal, the method further includes:
for the third audio signal and the fourth audio signal of an initial frame, obtaining the left channel signal by adding the third audio signal and the fourth audio signal, and obtaining the right channel signal by subtracting the phase-inverted fourth audio signal from the third audio signal;
determining a signal value of the third audio signal as a first signal value, determining a signal value of the left channel signal as a second signal value, and determining a signal value of the right channel signal as a third signal value;
calculating a weighted sum of the second signal value and the third signal value to obtain a target signal value;
determining a target gain based on the first signal value and the target signal value, the target gain is negatively correlated with the first signal value and positively correlated with the target signal value;
adjusting the third audio signal of a next frame with the target gain to obtain an intermediate audio signal, determining the intermediate audio signal as a new third audio signal, based on the new third audio signal and the fourth audio signal of the next frame, and returning to perform the obtaining the left channel signal by adding the third audio signal and the fourth audio signal and obtaining the right channel signal by subtracting the phase-inverted fourth audio signal from the third audio signal; and
in response to satisfying a preset separation termination condition, determining all obtained left channel signals and all obtained right channel signals as two-channel signals.

In an embodiment, the calculating, based on the two-channel signal, the sound source parameters corresponding to the sound source includes:
dividing the two-channel signal into a plurality of sub-band signals by frequency band division; and
for each sub-band signal, determining a target frequency band to which the sub-band signal belongs, and calculating sound source parameters corresponding to the sound source in the target frequency band based on the sub-band signal.

In an embodiment, the calculating the sound source parameters corresponding to the sound source in the target frequency band based on the sub-band signal includes:
calculating spatial cue parameters based on a left channel sub-signal and a right channel sub-signal in the sub-band signal, and determining the sound source parameters corresponding to the sound source in the target frequency band based on the spatial cue parameters,
the left channel sub-signal and the right channel sub-signal are within a same frequency band.

In an embodiment, the determining the sound source parameters corresponding to the sound source in the target frequency band based on the spatial cue parameters includes:
in response to the spatial cue parameters including an interaural time difference and the target frequency band being within a preset low-frequency band, determining a sound source orientation corresponding to the target frequency band based on the interaural time difference;
in response to the spatial cue parameters including an interaural level difference and the target frequency band being outside the preset low-frequency band, determining a sound source orientation corresponding to the target frequency band based on the interaural level difference; and
in response to the spatial cue parameters including an interaural cross-correlation coefficient, determining a sound source size corresponding to the sound source in the target frequency band based on the interaural cross-correlation coefficient.

In an embodiment, the calculating spatial cue parameters based on the left channel sub-signal and the right channel sub-signal in the sub-band signal includes:
in response to the sub-band signal including a plurality of left channel sub-signals or a plurality of right channel sub-signals, selecting one target left channel sub-signal and one target right channel sub-signal; and
calculating the spatial cue parameters based on the target left channel sub-signal and the target right channel sub-signal.

In addition, in order to achieve the above objectives, the present application further provides an audio device, the audio device includes an omnidirectional microphone, a figure-eight directional microphone, and a processor, the omnidirectional microphone and the figure-eight directional microphone are respectively connected to the processor, and the processor is configured to execute the steps of the signal generation method as described above.

In addition, in order to achieve the above objectives, the present application further provides a computer-readable storage medium, the computer-readable storage medium is a computer-readable storage medium, and a program for implementing the signal generation method is stored on the computer-readable storage medium, and the program for implementing the signal generation method is executed by a processor to implement the signal generation method as described above.

The present application further provides a computer program product including a computer program, when the computer program is executed by a processor, the steps of the signal generation method as described above are implemented.

One or more technical solutions provided in the present application at least have the following technical effects:

an omnidirectional microphone and a figure-eight directional microphone are integrated in an audio device for recording, and an original audio signal picked up by the omnidirectional microphone and an original audio signal picked up by the figure-eight directional microphone are obtained; channel separation processing is performed on the original audio signal to obtain a two-channel signal, the two-channel signal includes a left channel signal and a right channel signal; sound source parameters corresponding to a sound source are calculated based on the two-channel signal, and the original audio signal is rendered according to the sound source parameters to obtain a generated target audio signal, the sound source parameters include a sound source orientation and/or a sound source size. In this way, in the embodiments of the present application, the left channel signal and the right channel signal are separated from the original audio signal picked up by the omnidirectional microphone and the figure-eight directional microphone, so as to simulate, by the left channel signal and the right channel signal, sounds heard by two ears of a human, such that the figure-eight directional microphone and the omnidirectional microphone can be closely arranged. By means of the figure-eight directional microphone and the omnidirectional microphone, a very compact miniature directional recording device can be constructed, the device occupies a small space, and can be easily integrated into an audio device with a small size, thereby improving universality of stereo recording. Further, based on the two-channel signal, a sound source orientation and/or a sound source size are calculated, the sound source orientation enables a listener to determine a specific position of a sound source, thereby increasing spatial directional perception of the listener, and the sound source size can increase a depth sense of a sound, thereby increasing spatial depth perception of the listener. Therefore, both the sound source orientation and the sound source size can be used to restore a spatial sense of stereo. Accordingly, the original audio signal is rendered based on the sound source parameters, so as to simulate and render sounds heard by the listener according to the sound source parameters, such that a generated target audio signal obtained by rendering can better restore the spatial sense of the sound, thereby ensuring a stereo effect of the generated signal.

### BRIEF DESCRIPTION OF THE DRAWINGS

The accompanying drawings herein are incorporated into the specification and constitute a part of the specification, illustrate embodiments consistent with the present application, and, together with the specification, serve to explain principles of the present application.

In order to more clearly describe the technical solutions in the embodiments of the present application or in the prior art, the accompanying drawings required for describing the embodiments or the prior art will be briefly introduced below. Apparently, for those skilled in the art, other drawings may be obtained based on these drawings without creative efforts.

FIG. 1 is a schematic flowchart of a signal generation method according to an embodiment of the present application.

FIG. 2 is a schematic flowchart of the signal generation method according to an embodiment of the present application.

FIG. 3 is a schematic flowchart of the signal generation method according to an embodiment of the present application.

FIG. 4 is a schematic flowchart of the signal generation method according to an embodiment of the present application.

FIG. 5 is a schematic flowchart of the signal generation method according to an embodiment of the present application.

FIG. 6 is a schematic flowchart of the signal generation method according to an embodiment of the present application.

FIG. 7 is a schematic flowchart of the signal generation method according to an embodiment of the present application.

FIG. 8 is a schematic flowchart of the signal generation method according to an embodiment of the present application.

FIG. 9 is a schematic flowchart of the signal generation method according to an embodiment of the present application.

FIG. 10 is a schematic diagram of a computational initial time-delay gap (ITDG) scenario according to an embodiment of the signal generation method of the present application.

FIG. 11 is a schematic diagram of an ITDG variation curve according to an embodiment of the signal generation method of the present application.

FIG. 12 is a schematic structural diagram of a signal generation apparatus according to an embodiment of the present application.

FIG. 13 is a schematic diagram of a hardware operating environment of the signal generation apparatus according to an embodiment of the present application.

The purpose, features, and advantages of this application will be further explained in conjunction with the embodiments and with reference to the accompanying drawings.

### DETAILED DESCRIPTION OF THE EMBODIMENTS

In order to make the above objectives, features, and advantages of the present application more apparent and easier to understand, the technical solutions in the embodiments of the present application will be clearly and completely described below with reference to the accompanying drawings in the embodiments of the present application. Apparently, the described embodiments are only a part of the embodiments of the present application, rather than all of the embodiments. Based on the embodiments of the present application, all other embodiments obtained by those skilled in the art without creative efforts shall fall within a protection scope of the present application.

With the widespread use of open audio product devices such as augmented reality (AR), virtual reality (VR), and smart audio glasses, users have increasing immersive requirements for near-ear open audio devices. At present, in application scenarios of stereo recording, a user typically wears an audio device, and a sound signal in a surrounding environment is picked up by a pickup unit (for example, a microphone) of the audio device. Then, an audio signal obtained after pickup is stored, thereby obtaining a stereo recording signal. However, due to limitations of a spatial perception that can be presented by hardware devices, the recording signal obtained in the above manner cannot accurately represent spatial information of the sound signal and cannot achieve an effect of human ear perception. During subsequent playback, restoration of spatial perception cannot be achieved, resulting in poor user experience.

Conventional stereo recording generally requires two microphones or more than two microphones for recording, and during recording, a distance between the two microphones needs to be relatively large (generally 2 to 3 meters may be required), so as to obtain a stereo recording with relatively obvious left-right separation. When microphones are closely arranged (for example, in a mobile phone, a tablet, VR glasses, AR glasses, and the like), a recording effect may be similar to that of a single microphone, lacking a sense of stereo.

Based on this, a main solution of the present application is as follows: integrating an omnidirectional microphone and a figure-eight directional microphone in an audio device for recording, and obtaining an original audio signal picked up by the omnidirectional microphone and an original audio signal picked up by the figure-eight directional microphone; performing channel separation processing on the original audio signal to obtain a two-channel signal, wherein the two-channel signal comprises a left channel signal and a right channel signal; calculating, based on the two-channel signal, sound source parameters corresponding to a sound source, and rendering the original audio signal according to the sound source parameters to obtain a generated target audio signal, wherein the sound source parameters comprise a sound source orientation and/or a sound source size.

In the present application, a left channel signal and a right channel signal are separated from an original audio signal picked up by an omnidirectional microphone and a figure-eight directional microphone, so as to simulate, by the left channel signal and the right channel signal, sounds heard by two ears of a human, such that the figure-eight directional microphone and the omnidirectional microphone can be closely arranged. By means of the figure-eight directional microphone and the omnidirectional microphone, a very compact miniature directional recording apparatus can be constructed, the apparatus occupies a small space, and can be easily integrated into an audio device with a small size, thereby improving universality of stereo recording. Further, based on a two-channel signal, a sound source orientation and/or a sound source size are calculated, wherein the sound source orientation enables a listener to determine a specific position of a sound source, thereby increasing spatial directional perception of the listener, and the sound source size can increase a depth sense of a sound, thereby increasing spatial depth perception of the listener. Therefore, both the sound source orientation and the sound source size can be used to restore a spatial sense of stereo. Accordingly, the original audio signal is rendered based on the sound source parameters, so as to simulate and render sounds heard by the listener according to the sound source parameters, such that a generated target audio signal obtained by rendering can better restore the spatial sense of the sound, thereby ensuring a stereo effect of the generated signal.

It should be noted that an execution subject of each embodiment of the signal generation method of the present application may be an audio device capable of implementing the above functions, for example, earphones, AR glasses, AR helmets, VR glasses, VR helmets, smart audio glasses, and the like, and this embodiment does not specifically limit this.

Based on this, the present application provides a signal generation method, applied to an audio device, the audio device includes an omnidirectional microphone and a figure-eight directional microphone. Referring to FIG. 1, the signal generation method includes steps S10 to S30:

Step S10, obtaining an original audio signal, where the original audio signal includes a first audio signal and a second audio signal, the first audio signal is an audio signal picked up by the omnidirectional microphone, and the second audio signal is an audio signal picked up by the figure-eight directional microphone.

An omnidirectional microphone is a microphone capable of capturing sounds from various directions. A figure-eight directional microphone, also referred to as a supercardioid or bidirectional microphone, is a microphone having a specific directivity, which has relatively high sensitivity at a front side and a rear side of the microphone, and relatively low sensitivity at two lateral sides.

The omnidirectional microphone and the figure-eight directional microphone are respectively disposed at different positions to pick up a direct sound signal and an ambient sound signal. The direct sound signal refers to a signal that is directly propagated from a sound source to a pickup unit without undergoing any reflection or diffraction. The ambient sound signal refers to a signal obtained after a sound undergoes reflection, diffraction, and scattering during propagation, and includes multiple reflected sounds of sound waves on surfaces such as walls, a ceiling, and a floor in a room, as well as acoustic effects caused by a geometry and materials of the room.

Further, the audio device may include one or more omnidirectional microphones and one or more figure-eight directional microphones, and this embodiment does not specifically limit quantities of the omnidirectional microphone and the figure-eight directional microphone.

After the original audio signal is obtained, noise reduction processing may also be performed on the original audio signal, and subsequent processing is performed based on a noise-reduced original audio signal, so as to improve quality of the original audio signal.

Step S20, performing channel separation processing on the original audio signal to obtain a two-channel signal, where the two-channel signal includes a left channel signal and a right channel signal.

It should be noted that the left channel signal and the right channel signal are respectively used to simulate sound signals heard by two ears of a human.

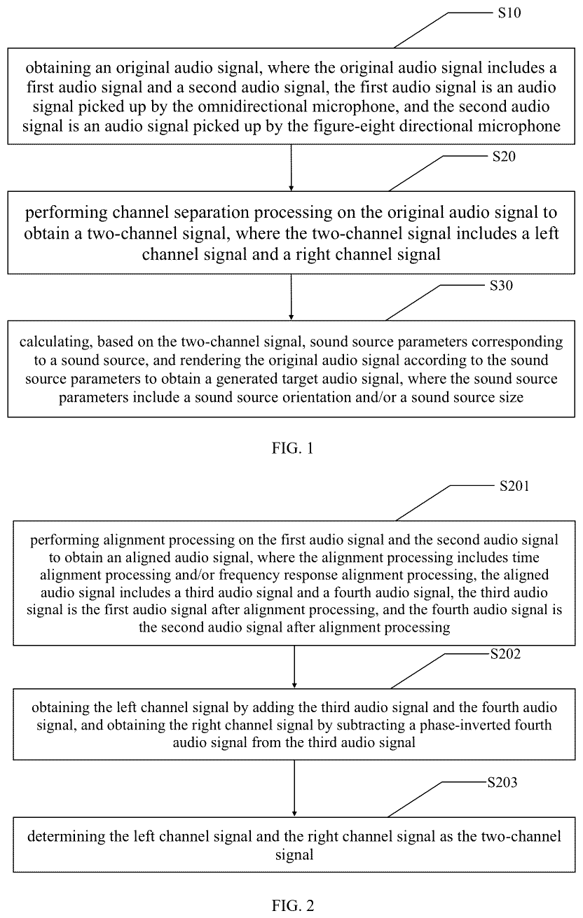

As shown in FIG. 2, in an embodiment, the performing channel separation processing on the original audio signal to obtain the two-channel signal includes steps S201 to S203:

Step S201, performing alignment processing on the first audio signal and the second audio signal to obtain an aligned audio signal, where the alignment processing includes time alignment processing and/or frequency response alignment processing, the aligned audio signal includes a third audio signal and a fourth audio signal, the third audio signal is the first audio signal after alignment processing, and the fourth audio signal is the second audio signal after alignment processing.

Considering that the omnidirectional microphone and the figure-eight directional microphone are disposed at different positions of the audio device, due to differences in arrangement positions, signals picked up by the omnidirectional microphone and the figure-eight directional microphone may have a certain relative time delay. In order to avoid determining a relative time delay caused by a position difference between the omnidirectional microphone and the figure-eight directional microphone as being caused by a sound source orientation, in this embodiment, alignment processing is performed on the first audio signal and the second audio signal. Specifically, a relative time delay between the two may be calculated, and time alignment processing is completed by delaying the first audio signal or the second audio signal by the delay time.

Specifically, delay=d/c*fs, where d represents a distance between the omnidirectional microphone and the figure-eight directional microphone, c represents a speed of sound, and fs represents a sampling rate of the omnidirectional microphone and the figure-eight directional microphone, and sampling rates of the two are set to be the same.

Frequency response refers to a response characteristic of a signal with respect to different frequency components, and describes a relationship between amplitude and phase of an output signal relative to a frequency of an input signal. Specifically, the frequency response includes an amplitude response and a phase response, where the amplitude response refers to a characteristic that an amplitude of the output signal varies with a frequency of the input signal, and the phase response refers to a characteristic that a phase of the output signal varies with a frequency of the input signal.

The frequency response alignment processing may specifically include aligning an amplitude response and a phase response of the first audio signal and the second audio signal, that is, aligning an amplitude response and a phase response of the omnidirectional microphone and the figure-eight directional microphone. In a specific implementation, output of the figure-eight directional microphone (that is, the second audio signal) is subjected to filtering processing in a time-frequency domain, so as to calibrate an amplitude response and a phase response of the output of the figure-eight directional microphone and align the amplitude response and the phase response of the output of the figure-eight directional microphone with an amplitude response and a phase response of the omnidirectional microphone, thereby avoiding influence caused by directivity and differences between different microphones, and ensuring that the omnidirectional microphone and the figure-eight directional microphone have consistent amplitude responses within a range of 0 to 180 degrees and only have a phase difference. The filtering processing in the time-frequency domain includes but is not limited to Normalized Least Mean Square (NLMS) filtering, convolution, Infinite Impulse Response (IIR) filtering, Finite Impulse Response (FIR) filtering, Fourier transform filtering, wavelet transform filtering, equalization processing, and the like.

In an embodiment, time alignment processing and frequency response alignment processing are performed on the first audio signal and the second audio signal, so as to eliminate signal differences caused by non-sound source factors such as position differences between the omnidirectional microphone and the figure-eight directional microphone and respective frequency response characteristics, thereby improving quality of subsequent signal separation.

Step S202, obtaining the left channel signal by adding the third audio signal and the fourth audio signal, and obtaining the right channel signal by subtracting a phase-inverted fourth audio signal from the third audio signal.

The third audio signal is denoted as Mid, and the fourth audio signal is denoted as Side, then the left channel signal and the right channel signal may be respectively expressed as: the left channel signal=Mid+Side (the Mid signal plus the Side signal without phase inversion), and the right channel signal=Mid−Side (the Mid signal minus the phase-inverted Side signal).

Step S203, determining the left channel signal and the right channel signal as the two-channel signal.

In addition, after the two-channel signal is obtained, a weighted average of an amplitude of the left channel signal (that is, a signal value) and an amplitude of the right channel signal may be used as a target amplitude, and gain control may be performed on the first audio signal (for example, if the target amplitude is A and an amplitude of the first audio signal is B, then the first audio signal may be adjusted by using A/B as a gain), so as to obtain an intermediate signal with an appropriate relative intensity. In this way, the left channel signal, the right channel signal, and the intermediate signal are separated from the original audio signal, so that related personnel may adjust the left channel signal, the right channel signal, and the intermediate signal during subsequent mixing to achieve an optimal stereo effect.

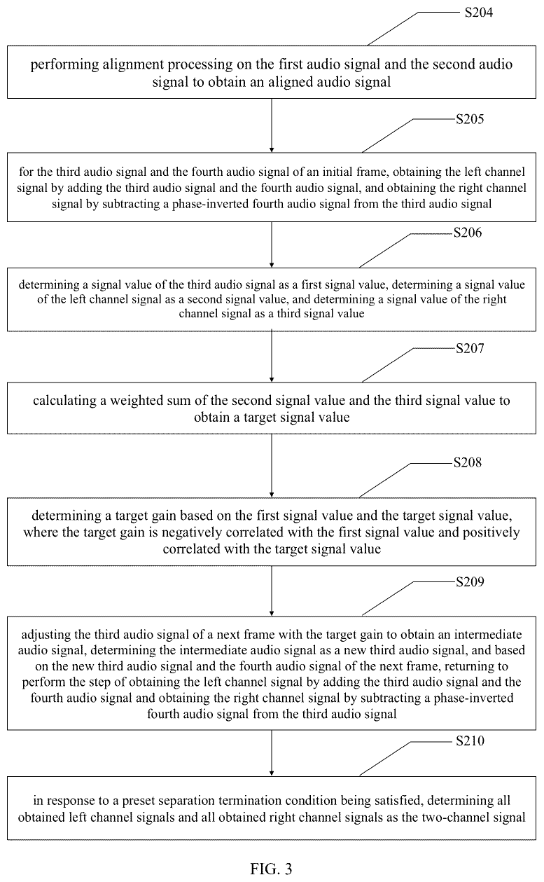

As shown in FIG. 3, in an embodiment, the performing channel separation processing on the original audio signal to obtain the two-channel signal includes steps S204 to S210:

Step S204, performing alignment processing on the first audio signal and the second audio signal to obtain an aligned audio signal.

The alignment processing is the same as the above alignment processing, and details are not described herein again.

Step S205, for the third audio signal and the fourth audio signal of an initial frame, obtaining the left channel signal by adding the third audio signal and the fourth audio signal, and obtaining the right channel signal by subtracting a phase-inverted fourth audio signal from the third audio signal.

For the third audio signal and the fourth audio signal of the initial frame, that is, for the third audio signal of a first frame and the fourth audio signal of the first frame, a left channel signal of the first frame is obtained by adding the third audio signal of the frame and the fourth audio signal of the frame, and similarly, a right channel signal of the first frame is obtained by subtracting a phase-inverted fourth audio signal of the frame from the third audio signal of the frame.

Step S206, determining a signal value of the third audio signal as a first signal value, determining a signal value of the left channel signal as a second signal value, and determining a signal value of the right channel signal as a third signal value.

The first signal value may specifically be an average value of signal values corresponding to all sampling points of the first audio signal. Similarly, the second signal value may be an average value of signal values corresponding to all sampling points of the left channel signal, and the third signal value may be an average value of signal values corresponding to all sampling points of the right channel signal.

Step S207, calculating a weighted sum of the second signal value and the third signal value to obtain a target signal value.

Step S208, determining a target gain based on the first signal value and the target signal value, where the target gain is negatively correlated with the first signal value and positively correlated with the target signal value.

Specifically, the target gain may be a ratio between the first signal value and the target signal value, for example, the target signal value divided by the first signal value is the target gain.

Step S209, adjusting the third audio signal of a next frame with the target gain to obtain an intermediate audio signal, determining the intermediate audio signal as a new third audio signal, and based on the new third audio signal and the fourth audio signal of the next frame, returning to perform the step of obtaining the left channel signal by adding the third audio signal and the fourth audio signal and obtaining the right channel signal by subtracting a phase-inverted fourth audio signal from the third audio signal.

Adjusting the third audio signal of the next frame with the target gain specifically includes multiplying the signal value by the target gain, for example, multiplying signal values corresponding to each sampling point by the target gain.

The intermediate audio signal obtained after adjustment is determined as the new third audio signal, that is, the third audio signal of the next frame, so as to perform sum and difference calculation with the fourth audio signal of the next frame, thereby obtaining a left channel signal of the next frame and a right channel signal of the next frame.

Step S210, in response to a preset separation termination condition being satisfied, determining all obtained left channel signals and all obtained right channel signals as the two-channel signal.

The preset separation termination condition may be a condition set by relevant personnel according to actual requirements, for example, a certain number of frames of the two-channel signal have been obtained, or the current frame (a signal frame for which sum and difference calculation is currently performed) of the third audio signal or the fourth audio signal is a last frame signal, and this embodiment does not specifically limit this.

It should be noted that one frame of the two-channel signal includes one frame of the left channel signal and one frame of the right channel signal.

Step S30, calculating, based on the two-channel signal, sound source parameters corresponding to a sound source, and rendering the original audio signal according to the sound source parameters to obtain a generated target audio signal, where the sound source parameters include a sound source orientation and/or a sound source size.

The sound source parameters may be used to simulate sounds heard by human ears, and include but are not limited to a sound source orientation and/or a sound source size, and may further include a sound source intensity. The sound source orientation refers to a spatial position of a sound source relative to a listener, and includes positions of the sound source on a horizontal plane (left-right and front-back) and a vertical plane (up-down). The sound source size refers to a volumetric sense of the sound source. The sound source size is not completely consistent with a physical size of the sound source, but is related to factors such as a spectral distribution of a sound, a dynamic range, and a reverberation effect. The sound source size may affect a listener's perception of spatial characteristics of the sound, and the spatial characteristics of the sound include width, depth, and height of the sound. The sound source intensity generally refers to loudness of a sound, that is, strength or volume of the sound, and is a measure of sound energy, and is closely related to a sound pressure level (SPL), and the sound source intensity determines a degree of influence of the sound on senses of the listener, which corresponds to a commonly understood “volume level”.

Considering that the sound source orientation enables a listener to determine a specific position of a sound source, which is a basis of a stereo system, through stereo imaging, the sound source may be positioned in front of, behind, to a left of, to a right of, above, and below the listener. The sound source size may increase a depth sense of a sound. For example, a sound having a longer reverberation time may be perceived as originating from a more distant space, thereby increasing spatial depth perception of the listener. By combining the sound source orientation and the sound source size, a more realistic and immersive audio signal may be rendered. For example, in a cinema or a home theater, through accurate sound source positioning and a reverberation effect, a spatial sense in a movie scene may be simulated, such that an audience feels as if being in an environment in which a story occurs. Based on this, in each embodiment of the present application, the sound source size and the sound source orientation are selected as the sound source parameters, so that a generated signal has a better spatial sense restoration effect.

A known manner may be used to calculate the sound source parameters based on two signals. For example, for the sound source size, the sound source size may be estimated based on frequency components of the two signals (a sound having a wide spectrum is generally perceived as a larger sound source), and for the sound source orientation, the sound source orientation may be calculated based on characteristics such as a time difference, an intensity difference, and a phase difference between the two signals, and this embodiment does not describe a specific calculation process of the sound source parameters in detail.

After the sound source parameters are obtained, the original audio signal is rendered according to the sound source parameters to obtain a generated target audio signal.

Rendering of a signal generally refers to a process of processing a sound signal so as to generate a required auditory effect on a specific playback device. In this embodiment, in order to restore a spatial sense of a sound, a stereo rendering manner is adopted. The stereo rendering is an audio processing technology that uses two or more channels to create a spatial sense of sound, and controls volume, frequency content, and time differences (phase differences) between different channels based on the sound source parameters, such that a listener perceives, during playback of a generated signal, that a sound originates from a sound source having the sound source parameters.

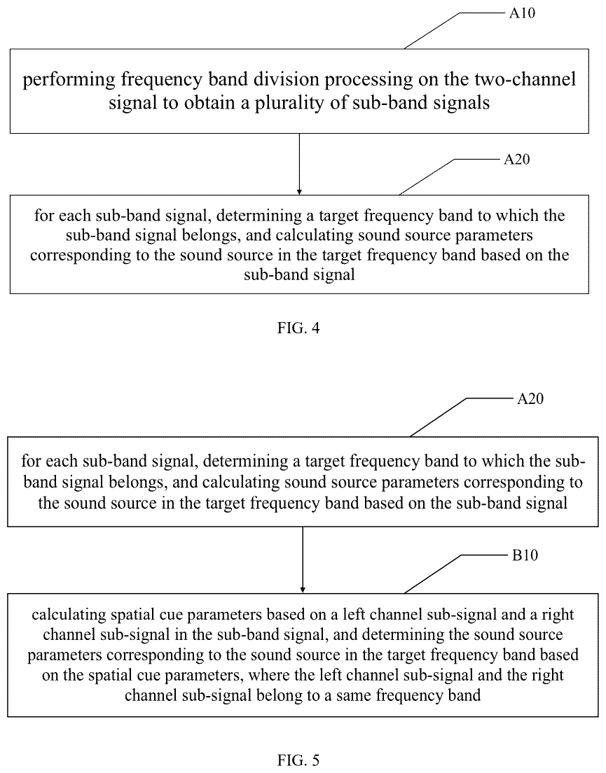

In this embodiment, an omnidirectional microphone and a figure-eight directional microphone are integrated in an audio device for recording, and an original audio signal picked up by the omnidirectional microphone and an original audio signal picked up by the figure-eight directional microphone are obtained; channel separation processing is performed on the original audio signal to obtain a two-channel signal, where the two-channel signal includes a left channel signal and a right channel signal; sound source parameters corresponding to a sound source are calculated based on the two-channel signal, and the original audio signal is rendered according to the sound source parameters to obtain a generated target audio signal, where the sound source parameters include a sound source orientation and/or a sound source size. In this way, in this embodiment, the left channel signal and the right channel signal are separated from the original audio signal picked up by the omnidirectional microphone and the figure-eight directional microphone, so as to simulate, by the left channel signal and the right channel signal, sounds heard by two ears of a human, such that the figure-eight directional microphone and the omnidirectional microphone can be closely arranged. By means of the figure-eight directional microphone and the omnidirectional microphone, a very compact miniature directional recording device can be constructed, the device occupies a small space, and can be easily integrated into an audio device with a small size, thereby improving universality of stereo recording. Further, based on the two-channel signal, a sound source orientation and/or a sound source size are calculated, where the sound source orientation enables a listener to determine a specific position of a sound source, thereby increasing spatial directional perception of the listener, and the sound source size can increase a depth sense of a sound, thereby increasing spatial depth perception of the listener. Therefore, both the sound source orientation and the sound source size can be used to restore a spatial sense of stereo. Accordingly, the original audio signal is rendered based on the sound source parameters, so as to simulate and render sounds heard by the listener according to the sound source parameters, such that a generated target audio signal obtained by rendering can better restore the spatial sense of the sound, thereby ensuring a stereo effect of the generated signal. Based on the above embodiments of the present application, in this embodiment, content that is the same as or similar to the above embodiments may be referred to the above description and is not described again. On this basis, as shown in FIG. 4, the calculating, based on the two-channel signal, the sound source parameters corresponding to the sound source includes:

Step A10, performing frequency band division processing on the two-channel signal to obtain a plurality of sub-band signals.

It should be noted that an audio signal initially picked up by a microphone is generally a time-domain signal. Accordingly, when the two-channel signal is a time-domain signal, Fourier transform is performed on the two-channel signal to obtain a frequency-domain two-channel signal, and the frequency band division processing is performed based on the frequency-domain two-channel signal.

One or more specific frequency boundaries may be set in advance, and the frequency band division processing is performed on the two-channel signal according to the preset frequency boundaries. In an embodiment, assuming that the preset frequency boundaries are A, B, C, and D, where A<B<C<D, the two-channel signal may be divided into four frequency bands f1, f2, f3, and f4 according to the frequency boundaries. Specifically, f1, f2, f3, and f4 may respectively correspond to less than A, [A, B), [B, C), and greater than or equal to C.

It should be noted that the two-channel signal includes a left channel signal and a right channel signal, and performing frequency band division processing on the two-channel signal refers to performing frequency band division processing on both the left channel signal and the right channel signal, and each sub-band signal obtained by the frequency band division processing includes a left channel sub-signal and a right channel sub-signal belonging to a same frequency band.

In an embodiment, the two-channel signal is denoted as M, a left channel signal in M is denoted as L, and a right channel signal in M is denoted as R. After performing frequency band division processing on M according to the frequency boundaries in the above example, four sub-band signals S1, S2, S3, and S4 respectively belonging to f1, f2, f3, and f4 are obtained. S1 includes [L1, R1], S2 includes [L2, R21, S3 includes [L3, R3], and S4 includes [L4, R4], where L1 represents a left channel sub-signal in L belonging to the f1 frequency band, L2 represents a left channel sub-signal in L belonging to the f2 frequency band, L3 represents a left channel sub-signal in L belonging to the f3 frequency band, L4 represents a left channel sub-signal in L belonging to the f4 frequency band, R1 represents a right channel sub-signal in R belonging to the f1 frequency band, R2 represents a right channel sub-signal in R belonging to the f2 frequency band, R3 represents a right channel sub-signal in R belonging to the f3 frequency band, and R4 represents a right channel sub-signal in R belonging to the f4 frequency band.

Step A20, for each sub-band signal, determining a target frequency band to which the sub-band signal belongs, and calculating sound source parameters corresponding to the sound source in the target frequency band based on the sub-band signal.

It should be noted that, based on a target frequency band to which each sub-band signal belongs, sound source parameters corresponding to the sound source in each target frequency band are calculated, that is, sound source parameters corresponding to the sound source in each frequency band are calculated, so as to generate, based on the sound source parameters corresponding to each frequency band, a target audio signal of the frequency band. In an embodiment, the sound source parameters are denoted as I, and the sub-band signals include S1, S2, S3, and S4, which respectively belong to target frequency bands f1, f2, f3, and f4. Then, sound source parameters 11 corresponding to the sound source in the f1 frequency band are calculated based on S1, sound source parameters 12 corresponding to the sound source in the f2 frequency band are calculated based on S2, sound source parameters 13 corresponding to the sound source in the f3 frequency band are calculated based on S3, and sound source parameters 14 corresponding to the sound source in the f4 frequency band are calculated based on S4. The finally obtained sound source parameters I specifically include I1, I2, I3, and I4. During rendering, I1 is used to generate a target audio signal of the f1 frequency band, I2 is used to generate a target audio signal of the f2 frequency band, I3 is used to generate a target audio signal of the f3 frequency band, and I4 is used to generate a target audio signal of the f4 frequency band.

Considering that the sound source parameters depend on frequency response characteristics of a sound source, the calculated sound source parameters may vary with frequency. Based on this, in this embodiment, frequency band division processing is performed on the original audio signal picked up by a pickup unit, and sound source parameters corresponding to the sound source in each frequency band are calculated, so as to render the original audio signal based on the sound source parameters corresponding to each frequency band, such that sounds in each frequency band have a better spatial sense restoration effect, thereby further improving the spatial sense restoration effect of the sound.

Based on the above embodiments of the present application, in this embodiment, content that is the same as or similar to the above embodiments may be referred to the above description and is not described again. On this basis, as shown in FIG. 5, the calculating the sound source parameters corresponding to the target frequency band based on the sub-band signal includes:

Step B10, calculating spatial cue parameters based on a left channel sub-signal and a right channel sub-signal in the sub-band signal, and determining the sound source parameters corresponding to the sound source in the target frequency band based on the spatial cue parameters, where the left channel sub-signal and the right channel sub-signal belong to a same frequency band.

The spatial cue parameters refer to various factors used to describe, during propagation of a sound in a three-dimensional space, perception of a sound source orientation and a sound source size. Specifically, the spatial cue parameters may include an Interaural Time Difference (ITD), an Interaural Level Difference (ILD), and an Interaural Cross-Correlation Coefficient (IACC), and this embodiment does not specifically limit this.

The ITD refers to a difference in time at which a sound wave arrives at two ears. Since human ears are located on two sides of a head, when a sound source is located on a left side or a right side of the head, a sound wave arrives at a near-side ear earlier than it arrives at a far-side ear. A brain can determine a position of the sound source relative to the head by detecting the time difference. By measuring the difference in time at which the sound wave arrives at the two ears, a horizontal orientation of the sound source may be estimated.

Specifically, the ITD can be calculated using known manner, such as:

$$ITD = {argmax}_{d} \{ {\sum }_{n = 0}^{N - 1} {x}_{1} ( n ) {x}_{2} ( n + d ) / {\sum }_{n = 0}^{N - 1} {x}_{1}^{2} ( n ) {\sum }_{n = 0}^{N - 1} {x}_{2}^{2} ( n + d ) \} ,$$

where n represents an index of a sampling point (an index of an i-th sampling point is i−1), N represents a total number of sampling points, x1 and x2 respectively represent the left channel sub-signal and the right channel sub-signal, x1(n) represents a signal value of a sampling point of the left channel sub-signal having an index n, x2(n) represents a signal value of a sampling point of the right channel sub-signal having an index n, d represents a number of delayed samples, and argmax_{d} represents the value of d when the maximum value is returned.

The ILD refers to a difference in intensity or volume when a sound wave arrives at two ears. Since human ears are located on two sides of a head, when a sound source is located on a left side or a right side of the head, during propagation, the sound wave produces an intensity difference due to factors such as distance, head shadowing, and pinna filtering effects. The intensity difference of the sound wave arriving at the two ears provides horizontal orientation and distance information of the sound source. When the sound source is biased to one side, an ear farther from the sound source receives a sound with reduced intensity. Specifically, a known manner may be used to calculate the ILD, such as:

$$10 {log}_{10} ( {\sum }_{n = 0}^{N - 1} {x}_{1}^{2} ( n ) / {\sum }_{n = 0}^{N - 1} {x}_{2}^{2} ( n ) ) .$$

The IACC refers to a parameter indicating a degree of similarity between sound signals received by two ears. It is a dimensionless parameter, and a value thereof ranges from +1 to −1. Specifically, a known manner may be used to calculate the IACC, for example:

$$IACC = {\sum }_{n = 0}^{N - 1} ( {p}_{1} ( n ) - {\overline{p}}_{1} ) ( {p}_{2} ( n ) - {\overline{p}}_{2} ) / ( {\sum }_{n = 0}^{N - 1} {( {p}_{1} ( n ) - {\overline{p}}_{1} )}^{2} + {\sum }_{n = 0}^{N - 1} {( {p}_{1} ( n ) - {\overline{p}}_{1} )}^{2} ) ,$$

where p1 represents a sound pressure signal of the left channel sub-signal, p2 represents a sound pressure signal of the right channel sub-signal, p̅₁ represents a signal mean value of the sound pressure signal of the left channel sub-signal, and p̅₂ represents a signal mean value of the sound pressure signal of the right channel sub-signal.

With respect to a specific calculation manner of the sound source parameters, as one implementation, a parameter calculation model may be pre-trained by using a machine learning manner. In this way, the spatial cue parameters are input into the pre-trained parameter calculation model, and the sound source parameters may be output.

As another implementation, a mapping table may be set based on a correlation between the sound source parameters and the spatial cue parameters, and the sound source parameters are obtained by lookup based on the mapping table. For example, the ITD and the ILD each have a certain correlation with the sound source orientation. Based on the correlation, mapping relationships between the ITD and the sound source orientation and between the ILD and the sound source orientation may be respectively set. The IACC has a certain correlation with the sound source size, and based on the correlation, a mapping relationship between the IACC and the sound source size may be set.

The above are merely two implementations provided in this embodiment for calculating the sound source parameters based on the spatial cue parameters, and this embodiment does not specifically limit a specific implementation manner for calculating the sound source parameters based on the spatial cue parameters.

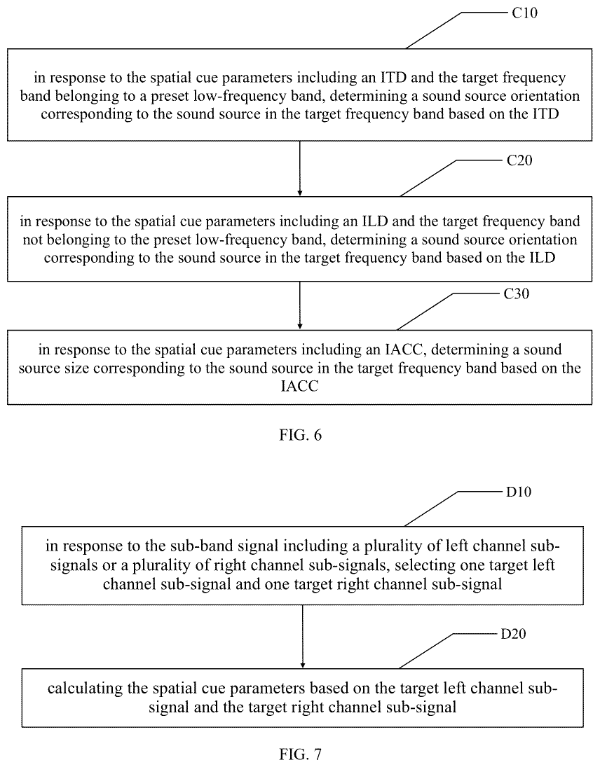

As shown in FIG. 6, in an embodiment, the determining the sound source parameters corresponding to the sound source in the target frequency band based on the spatial cue parameters includes:
Step C10, in response to the spatial cue parameters including an ITD and the target frequency band belonging to a preset low-frequency band, determining a sound source orientation corresponding to the sound source in the target frequency band based on the ITD;
Step C20, in response to the spatial cue parameters including an ILD and the target frequency band not belonging to the preset low-frequency band, determining a sound source orientation corresponding to the sound source in the target frequency band based on the ILD;
the preset low-frequency band is a frequency band set in advance. Considering that, in a frequency band above 1.5 kHz, a correlation between the ILD and the sound source orientation is relatively strong, and in a frequency band below 1.5 kHz, a correlation between the ITD and the sound source orientation is relatively strong, the preset low-frequency band may be a frequency band less than or equal to 1.5 kHz.

It should be noted that, in order to avoid a case where a part of a target frequency band belongs to the preset low-frequency band while another part does not belong to the preset low-frequency band, for example, when the preset low-frequency band is less than or equal to 1.5 kHz and a target frequency band is 0.8 kHz to 2 kHz, when setting frequency boundaries for performing frequency band division processing on the original audio signal, the set frequency boundaries at least include a frequency boundary of the preset low-frequency band.

Step C30, in response to the spatial cue parameters including an IACC, determining a sound source size corresponding to the sound source in the target frequency band based on the IACC.

In this embodiment, considering that, in a low-frequency band, the ITD is relatively sensitive to variation of the sound source orientation and has a relatively strong correlation with the sound source orientation, and in a high-frequency band, the ILD is relatively sensitive to variation of the sound source orientation and has a relatively strong correlation with the sound source orientation, accordingly, when the target frequency band belongs to the preset low-frequency band, the sound source orientation corresponding to the sound source in the target frequency band is determined based on the ITD, and when the target frequency band does not belong to the preset low-frequency band, the sound source orientation corresponding to the sound source in the target frequency band is determined based on the ILD, thereby improving accuracy of the determined sound source orientation. Moreover, the IACC is relatively sensitive to variation of the sound source size and has a certain correlation with the sound source size, and accordingly, the sound source size is determined based on the IACC.

As shown in FIG. 7, in an embodiment, the calculating spatial cue parameters based on the left channel sub-signal and the right channel sub-signal in the sub-band signal includes:

Step D10, in response to the sub-band signal including a plurality of left channel sub-signals or a plurality of right channel sub-signals, selecting one target left channel sub-signal and one target right channel sub-signal;

it may be understood that when a plurality of omnidirectional microphones or a plurality of figure-eight directional microphones are present, a plurality of audio signals are correspondingly picked up, and a plurality of sub-audio signals are correspondingly present in the sub-band signal. In this case, one target left channel sub-signal and one target right channel sub-signal may be randomly selected.

Step D20, calculating the spatial cue parameters based on the target left channel sub-signal and the target right channel sub-signal.

In this embodiment, when a plurality of left channel sub-signals or a plurality of right channel sub-signals are present, one target left channel sub-signal and one target right channel sub-signal are selected to calculate the spatial cue parameters, thereby reducing a number of audio signals participating in calculation, and further reducing an amount of computation.

In addition, in another embodiment, one left channel sub-signal and one right channel sub-signal may be combined sequentially, and a spatial cue parameter is calculated based on the left channel sub-signal and the right channel sub-signal of a current combination. Finally, an average parameter of spatial cue parameters calculated for all combinations is determined, and the average parameter is used as a finally calculated spatial cue parameter. In this way, an accidental error of a certain audio signal, for example, failure to pick up a signal occasionally, is reduced, thereby avoiding a phenomenon that the calculated spatial cue parameter is incorrect, and improving accuracy of the finally calculated spatial cue parameter.

For example, assuming that the audio device includes two omnidirectional microphones and two figure-eight directional microphones, left channel audio signals picked up by the two omnidirectional microphones are respectively L1 and L2, and right channel audio signals picked up by the two figure-eight directional microphones are respectively R1 and R2. The original audio signal M includes L1, L2, R1, and R2. After performing frequency band division processing on M based on two frequency bands f1 and f2, two sub-band signals S1 and S2 are obtained, where S1 includes [L1_1, L2_1, R1_1, R2_1], and S2 includes [L1_2, L2_2, R1_2, R2_2]. Then, for the sub-band signal S1, a spatial cue parameter D1 may be calculated based on L1_1 and R1_1, a spatial cue parameter D2 may be calculated based on L1_1 and R2_1, a spatial cue parameter D3 may be calculated based on L2_1 and R1_1, and a spatial cue parameter D4 may be calculated based on L2_1 and R2_1. An average value of D1, D2, D3, and D4 is used as a final spatial cue parameter corresponding to S1. It should be noted that when the spatial cue parameters include a plurality of parameters, an average value is respectively taken for each parameter.

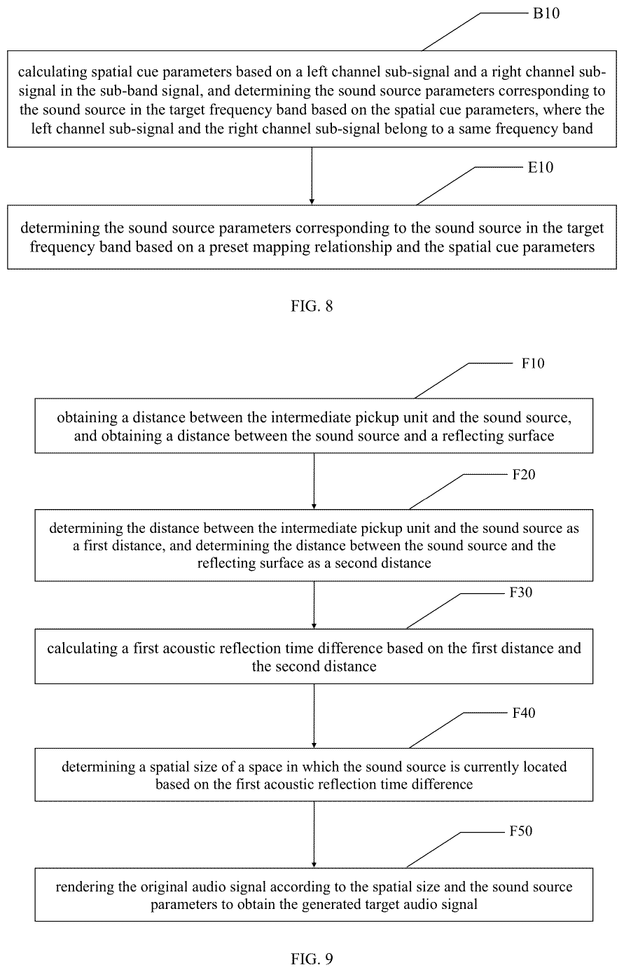

As shown in FIG. 8, in an embodiment, the determining the sound source parameters corresponding to the sound source in the target frequency band based on the spatial cue parameters includes:

Step E10, determining the sound source parameters corresponding to the sound source in the target frequency band based on a preset mapping relationship and the spatial cue parameters.

Specifically, corresponding mapping relationships may be respectively set according to corresponding relationships between different spatial cues and different sound source parameters. For example, mapping relationships between different ITDs and the sound source orientation, mapping relationships between different ILDs and the sound source orientation, and mapping relationships between different IACCs and the sound source size may be respectively set. In this way, the sound source parameters may be obtained based on the mapping relationships, thereby reducing a calculation amount and improving efficiency of calculating the sound source parameters.

Based on the above embodiments of the present application, in this embodiment, content that is the same as or similar to the above embodiments may be referred to the above description and is not described again. On this basis, as shown in FIG. 9, the audio device further includes an intermediate pickup unit. After the calculating, based on the original audio signal, the sound source parameters corresponding to the sound source, the method further includes:

Step FlU, obtaining a distance between the intermediate pickup unit and the sound source, and obtaining a distance between the sound source and a reflecting surface;

the reflecting surface specifically refers to a plane at which an audio signal played by the sound source is first reflected during propagation. For convenience of subsequent description and explanation, a distance between the sound source and the reflecting surface is denoted as d_{b}, and a distance between the intermediate pickup unit and the sound source is denoted as d_{d}.

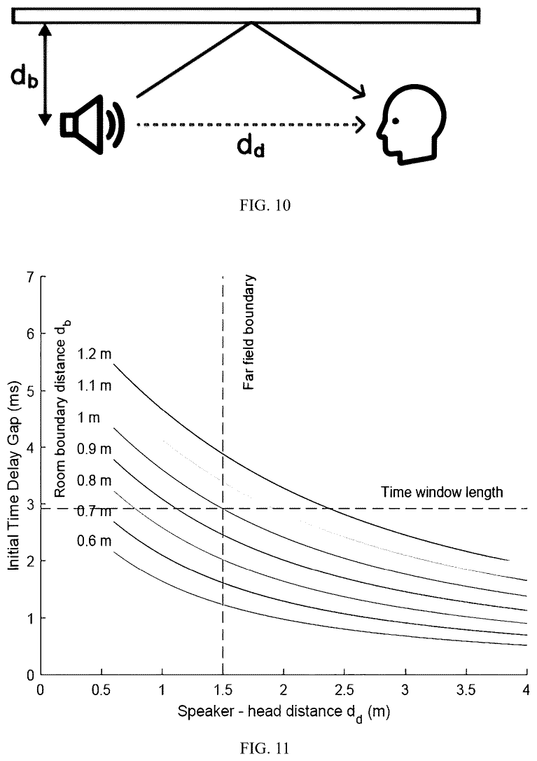

In an embodiment, as shown in FIG. 10, a user wears an audio device, a sound source is a loudspeaker, and audio played by the loudspeaker is first reflected on a wall during propagation, then the wall is the reflecting surface, d_{b} is a distance between the loudspeaker and the wall, and a distance between the intermediate pickup unit and the loudspeaker is approximately equal to a distance between the user and the loudspeaker, and the distance between the user and the loudspeaker is taken as d_{d}.

Step F20, determining the distance between the intermediate pickup unit and the sound source as a first distance, and determining the distance between the sound source and the reflecting surface as a second distance;

Step F30, calculating a first acoustic reflection time difference based on the first distance and the second distance;

the first acoustic reflection time difference is a rate of change of a difference in time at which a sound wave arrives at two ears. This parameter reflects how the difference in time at which the sound wave arrives at the two ears varies with variation of the sound source orientation due to factors such as a position and a shape of the sound source, and shapes of a head and ears of a listener during propagation of the sound wave in space.

Specifically, a first acoustic reflection time difference (Initial Time-delay Gap, ITDG) may be calculated based on a preset formula:

$$ITDG = ( 2 * \sqrt{{d}_{d}^{2} / 2 - {d}_{b}^{2}} - {d}_{d} ) * {c}^{- 1}$$

where c represents a speed of sound.

Step F40, determining a spatial size of a space in which the sound source is currently located based on the first acoustic reflection time difference.

In an embodiment, as shown in FIG. 11, a vertical axis of FIG. 11 represents ITDG with a unit of milliseconds, and a horizontal axis represents dd with a unit of meters. Under different d_{b} (0.6 m, 0.7 m, 0.8 m, 0.9 m, 1 m, 1.1 m, 1.2 m shown in FIG. 11), variation curves of ITDG with respect to dd are illustrated. It can be seen that when dd is constant, ITDG is positively correlated with d_{b}, and d_{b} is generally positively correlated with the spatial size of the current space. Accordingly, based on the correlation, the spatial size may be determined according to the ITDG.

The rendering the original audio signal according to the sound source parameters to obtain the generated target audio signal includes:

Step F50, rendering the original audio signal according to the spatial size and the sound source parameters to obtain the generated target audio signal.

By rendering the original audio signal based on the spatial size and the sound source parameters, a spatial sense restoration effect of the generated target audio signal is further improved.

In an embodiment, in order to facilitate understanding of a technical concept or a technical principle of signal generation in this embodiment in combination with the above embodiments, a specific embodiment is provided. In this specific embodiment, a signal generation process is as follows:
(1) an omnidirectional microphone picks up and obtains an omnidirectional microphone signal (that is, the first audio signal);
(2) a figure-eight microphone pickup module obtains a figure-eight directional microphone signal (that is, the second audio signal), and based on positions of the omnidirectional microphone and the figure-eight directional microphone, a relative delay between the figure-eight directional microphone and the omnidirectional microphone is calculated according to a formula as follows: delay=d/c*fs;
(3) after delay processing, output of the figure-eight directional microphone is subjected to filtering processing in a time-frequency domain. An amplitude response and a phase response of the output of the figure-eight directional microphone are calibrated and aligned with an amplitude response and a phase response of the omnidirectional microphone, so as to ensure that the omnidirectional microphone and the figure-eight directional microphone have consistent amplitude responses within a range of 0 to 180 degrees and only have a phase difference. The filtering processing in the time-frequency domain includes but is not limited to NLMS filtering, convolution, IIR filtering, FIR filtering, Fourier transform filtering, wavelet transform filtering, and equalization processing;
(4) sum and difference calculation is performed on the processed omnidirectional microphone signal and the figure-eight directional microphone signal. When amplitude-frequency responses and phase responses of the two signals are consistent in a front direction, addition processing is performed on the two signals to obtain a beam pointing to the front direction (that is, the left channel signal); when the signals are in a 180-degree direction, subtraction processing is performed on the two signals to obtain a beam pointing to a rear direction (that is, the right channel signal), thereby achieving separation of the left channel signal and the right channel signal. Information in a 90-degree direction may be provided by adjusting an amplitude of the omnidirectional microphone;
(5) signals in a left-side direction and a right-side direction may be obtained by performing amplitude processing on the omnidirectional microphone signal. A weighted average of amplitudes of the left channel signal and the right channel signal is used as a target amplitude, and gain control is performed on output of the omnidirectional microphone, so as to obtain intermediate channel output information with an appropriate relative intensity;
(6) time-frequency transformation and frequency band division processing are performed on the two-channel signal to obtain sub-band signals respectively belonging to four frequency bands, where the four frequency bands are a low frequency band (less than 200 Hz), a low-middle frequency band (200 Hz to 1.5 kHz), a high-middle frequency band (1.5 kHz to 4 kHz), and a high frequency band (greater than 4 kHz);
(7) spatial cue parameters are respectively extracted for the sub-band signals of the four frequency bands; the spatial cue parameters include an ITD, an ILD, and an IACC;
(8) the sound source size is calculated based on the IACC, the sound source orientation is calculated based on a correspondence between the ITD and the sound source orientation in the low frequency band and the low-middle frequency band, and the sound source orientation is calculated based on a correspondence between the ILD and the sound source orientation in the high-middle frequency band and the high frequency band;
(9) the ITDG is calculated, and a spatial size is estimated based on the ITDG;
(10) the original audio signal is respectively rendered based on the sound source orientation, the sound source size, and the spatial size, so as to generate a target audio signal.

It can be seen that the finally generated target audio signal fully integrates orientation information of the sound source, can well represent spatial information of the sound signal, and after playback, can achieve an effect of human ear perception, thereby improving user experience.

It should be noted that the above specific embodiment is only used for understanding the present application, and does not constitute a limitation on the signal generation process of the present application. Based on the technical concept, more forms of simple variations fall within a protection scope of the present application.

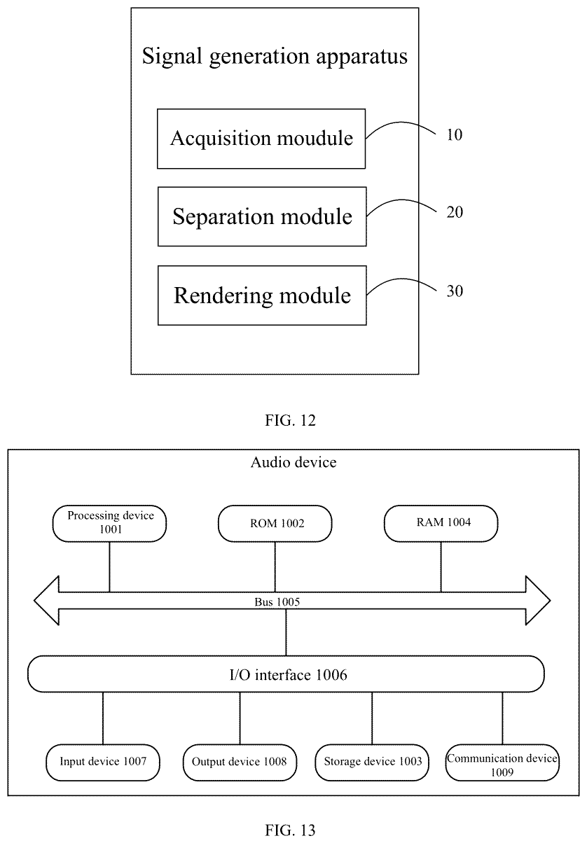

In addition, embodiments of the present application further provide a signal generation apparatus. Referring to FIG. 12, the signal generation apparatus includes an omnidirectional microphone and a figure-eight directional microphone, and the signal generation apparatus further includes an acquisition module 10, a separation module 20 and a rendering module 30.

The acquisition module 10 is configured to obtain an original audio signal picked up, where the original audio signal includes a first audio signal and a second audio signal, the first audio signal is an audio signal picked up by the omnidirectional microphone, and the second audio signal is an audio signal picked up by the figure-eight directional microphone.

The separation module 20 is configured to perform channel separation processing on the original audio signal to obtain a two-channel signal, where the two-channel signal includes a left channel signal and a right channel signal.

The rendering module 30 is configured to calculate, based on the two-channel signal, sound source parameters corresponding to a sound source, and render the original audio signal according to the sound source parameters to obtain a generated target audio signal, where the sound source parameters include a sound source orientation and/or a sound source size.

In an embodiment, the separation module 20 is further configured to:
perform alignment processing on the first audio signal and the second audio signal to obtain an aligned audio signal, where the alignment processing includes time alignment processing and/or frequency response alignment processing, the aligned audio signal includes a third audio signal and a fourth audio signal, the third audio signal is the first audio signal after alignment processing, and the fourth audio signal is the second audio signal after alignment processing;
obtain the left channel signal by adding the third audio signal and the fourth audio signal, and obtain the right channel signal by subtracting a phase-inverted fourth audio signal from the third audio signal; and
determine the left channel signal and the right channel signal as the two-channel signal.

In an embodiment, the separation module 20 is further configured to:
for the third audio signal and the fourth audio signal of an initial frame, obtain the left channel signal by adding the third audio signal and the fourth audio signal, and obtain the right channel signal by subtracting a phase-inverted fourth audio signal from the third audio signal;
determine a signal value of the third audio signal as a first signal value, determine a signal value of the left channel signal as a second signal value, and determine a signal value of the right channel signal as a third signal value;
calculate a weighted sum of the second signal value and the third signal value to obtain a target signal value;
determine a target gain based on the first signal value and the target signal value, where the target gain is negatively correlated with the first signal value and positively correlated with the target signal value;
adjust the third audio signal of a next frame with the target gain to obtain an intermediate audio signal, determine the intermediate audio signal as a new third audio signal, and based on the new third audio signal and the fourth audio signal of the next frame, return to perform the step of obtaining the left channel signal by adding the third audio signal and the fourth audio signal and obtaining the right channel signal by subtracting a phase-inverted fourth audio signal from the third audio signal; and
in response to a preset separation termination condition being satisfied, determine all obtained left channel signals and all obtained right channel signals as the two-channel signal.

In an embodiment, the rendering module 30 is further configured to:
perform frequency band division processing on the two-channel signal to obtain a plurality of sub-band signals;
for each sub-band signal, determine a target frequency band to which the sub-band signal belongs, and calculate sound source parameters corresponding to the sound source in the target frequency band based on the sub-band signal.

In an embodiment, the rendering module 30 is further configured to:
calculate spatial cue parameters based on a left channel sub-signal and a right channel sub-signal in the sub-band signal, and determine the sound source parameters corresponding to the sound source in the target frequency band based on the spatial cue parameters;
where the left channel sub-signal and the right channel sub-signal belong to a same frequency band.

In an embodiment, the rendering module 30 is further configured to:
in response to the spatial cue parameters including an ITD and the target frequency band belonging to a preset low-frequency band, determine a sound source orientation corresponding to the sound source in the target frequency band based on the ITD;
in response to the spatial cue parameters including an ILD and the target frequency band not belonging to the preset low-frequency band, determine a sound source orientation corresponding to the sound source in the target frequency band based on the ILD; and
in response to the spatial cue parameters including an IACC, determine a sound source size corresponding to the sound source in the target frequency band based on the IACC.

In an embodiment, the rendering module 30 is further configured to:
in response to the sub-band signal including a plurality of left channel sub-signals or a plurality of right channel sub-signals, select one target left channel sub-signal and one target right channel sub-signal; and
calculate the spatial cue parameters based on the target left channel sub-signal and the target right channel sub-signal.

In addition, embodiments of the present application further provide an audio device, where the audio device includes an omnidirectional microphone, a figure-eight directional microphone, and a processor, the omnidirectional microphone and the figure-eight directional microphone are respectively connected to the processor, and the processor is configured to execute steps of the signal generation method as described above.

As shown in FIG. 5, the audio device may further include a processing device 1001 (for example, a central processing unit, a graphics processing unit, etc.), which may execute various appropriate actions and processing according to a program stored in a read-only memory (ROM) 1002 or a program loaded from a storage device 1003 into a random access memory (RAM) 1004. Various programs and data required for operation of the audio device are also stored in the RAM 1004. The processing device 1001, the ROM 1002, and the RAM 1004 are connected to each other via a bus 1005. An input/output (I/O) interface 1006 is also connected to the bus. Generally, the following systems may be connected to the I/O interface 1006: an input device 1007 including, for example, a touch screen, a touch panel, an image sensor, a microphone, an accelerometer, a gyroscope, etc.; an output device 1008 including, for example, a liquid crystal display (LCD), a loudspeaker, a vibrator, etc.; a storage device 1003 including, for example, a magnetic tape, a hard disk, etc.; and a communication device 1009. The communication device 1009 may allow the audio device to perform wireless or wired communication with other devices so as to exchange data. Although the audio device including various systems is shown in the figure, it should be understood that it is not required to implement or provide all the illustrated systems, and alternatively, more or fewer systems may be implemented or provided.

In particular, according to the embodiments disclosed in the present application, the processes described above with reference to flowcharts may be implemented as computer software programs. For example, the embodiments disclosed in the present application include a computer program product, which includes a computer program carried on a computer-readable medium, and the computer program includes program code for performing the method shown in the flowcharts. In such embodiments, the computer program may be downloaded and installed from a network via a communication device, or installed from the storage device 1003, or installed from the ROM 1002. When the computer program is executed by the processing device 1001, the above functions defined in the method of the embodiments of the present application are implemented.

The audio device provided in the embodiments of the present application adopts the signal generation method in the above embodiments, and can solve a technical problem of how to improve universality of stereo recording. Compared with the prior art, beneficial effects of the audio device provided in the present application are the same as beneficial effects of the signal generation method provided in the above embodiments, and other technical features in the audio device are the same as features disclosed in the method in the above embodiments, and are not described herein again.

It should be understood that each part disclosed in the present application may be implemented by hardware, software, firmware, or a combination thereof. In the description of the above embodiments, specific features, structures, materials, or characteristics may be combined in any suitable manner in one or more embodiments or examples.

The above descriptions are only specific implementations of the present application, but a protection scope of the present application is not limited thereto. Any person skilled in the art, within a technical scope disclosed in the present application, may easily conceive of changes or substitutions, and such changes or substitutions shall fall within the protection scope of the present application. Therefore, the protection scope of the present application shall be subject to the protection scope of the claims.

In addition, in order to achieve the above objectives, embodiments of the present application further provide a computer-readable storage medium having computer-readable program instructions (that is, a computer program) stored thereon, where the computer-readable program instructions are used to execute the signal generation method in the above embodiments.

The computer-readable storage medium provided in the embodiments of the present application may be, for example, a USB flash drive, but is not limited to, an electrical, magnetic, optical, electromagnetic, infrared, or semiconductor system, apparatus, or device, or any combination thereof. More specific examples of the computer-readable storage medium may include, but are not limited to: an electrical connection having one or more wires, a portable computer disk, a hard disk, a RAM, a ROM, an EPROM, an optical fiber, a portable CD-ROM, an optical storage device, a magnetic storage device, or any suitable combination of the above. In this embodiment, the computer-readable storage medium may be any tangible medium that contains or stores a program, and the program may be used by or in conjunction with an instruction execution system, apparatus, or device. Program code contained in the computer-readable storage medium may be transmitted using any appropriate medium, including but not limited to: a wire, an optical cable, a radio frequency (RF), and the like, or any suitable combination of the above.

The computer-readable storage medium may be included in the audio device, or may exist independently without being assembled into the audio device.

The computer-readable storage medium carries one or more programs, and when the one or more programs are executed by the audio device, the audio device is caused to: obtain an original audio signal picked up, where the original audio signal includes a first audio signal and a second audio signal, the first audio signal is an audio signal picked up by the omnidirectional microphone, and the second audio signal is an audio signal picked up by the figure-eight directional microphone; perform channel separation processing on the original audio signal to obtain a two-channel signal, where the two-channel signal includes a left channel signal and a right channel signal; and calculate, based on the two-channel signal, sound source parameters corresponding to a sound source, and render the original audio signal according to the sound source parameters to obtain a generated target audio signal, where the sound source parameters include a sound source orientation and/or a sound source size.

Computer program code for performing operations of the present application may be written in one or more programming languages or combinations thereof, the programming languages include object-oriented programming languages such as Java, Smalltalk, and C++, and also include conventional procedural programming languages such as the “C” language or similar programming languages. The program code may be executed entirely on a user computer, partly on the user computer, as a standalone software package, partly on the user computer and partly on a remote computer, or entirely on a remote computer or a server. In a case involving the remote computer, the remote computer may be connected to the user computer through any type of network, including a local area network (LAN) or a wide area network (WAN), or may be connected to an external computer (for example, through the Internet by using an Internet service provider).

Flowcharts and block diagrams in the drawings illustrate possible architectures, functions, and operations of systems, methods, and computer program products according to various embodiments of the present application. In this regard, each block in the flowcharts or block diagrams may represent a module, a program segment, or a portion of code, and the module, the program segment, or the portion of code includes one or more executable instructions for implementing specified logical functions. It should also be noted that, in some alternative implementations, functions noted in the blocks may occur in an order different from that noted in the drawings. For example, two blocks shown in succession may actually be executed substantially in parallel, and sometimes may be executed in a reverse order, depending upon involved functions. It should also be noted that each block in the block diagrams and/or flowcharts, and a combination of blocks in the block diagrams and/or flowcharts, may be implemented by a dedicated hardware-based system that performs specified functions or operations, or may be implemented by a combination of dedicated hardware and computer instructions.

Modules described in the embodiments of the present application may be implemented in a software manner, or may be implemented in a hardware manner. In some cases, names of the modules do not constitute a limitation on the modules themselves.

The computer-readable storage medium provided in the present application is a computer-readable storage medium, and the computer-readable storage medium stores computer-readable program instructions (that is, a computer program) for executing the above signal generation method, and can solve a technical problem of how to improve universality of stereo recording. Compared with the prior art, beneficial effects of the computer-readable storage medium provided in the present application are the same as beneficial effects of the signal generation method provided in the above embodiments, and are not described herein again.

In addition, embodiments of the present application further provide a computer program product including a signal generation program, where when the signal generation program is executed by a processor, steps of the signal generation method as described above are implemented.

A specific implementation of the computer program product of the present application is substantially the same as the embodiments of the signal generation method described above, and is not described herein again.

It should be noted that, in this specification, the terms “comprise”, “include”, or any other variations thereof are intended to cover a non-exclusive inclusion, such that a process, a method, an article, or a system that comprises a series of elements not only comprises those elements, but also comprises other elements not explicitly listed, or further comprises elements inherent to such process, method, article, or system. Without further limitation, an element defined by the phrase “comprising one . . . ” does not exclude existence of additional identical elements in the process, the method, the article, or the system that comprises the element.

Numbers of the embodiments of the present application are only for description and do not represent superiority or inferiority of the embodiments.

Through the above description of the embodiments, those skilled in the art can clearly understand that the methods of the above embodiments may be implemented by software in combination with a necessary general hardware platform, and may also be implemented by hardware. However, in many cases, the former is a preferable implementation manner. Based on such understanding, a technical solution of the present application, or a part thereof that contributes to the prior art, may be embodied in a form of a software product, and the computer software product is stored in a storage medium as described above (such as a ROM/RAM, a magnetic disk, an optical disk), and comprises a plurality of instructions for enabling a terminal device (which may be a mobile phone, a computer, a server, an air conditioner, a network device, etc.) to execute the methods described in the embodiments of the present application.

The above are only some embodiments of the present application, and are not intended to limit a patent scope of the present application. Any equivalent structure or equivalent process transformation made by using the description and drawings of the present application, or directly or indirectly applied in other related technical fields, shall fall within the patent protection scope of the present application.

What is claimed is:

1. A signal generation method, applied to an audio device comprising an omnidirectional microphone and a figure-eight directional microphone, the signal generation method comprising:
obtaining an original audio signal, wherein the original audio signal comprises a first audio signal and a second audio signal, the first audio signal is an audio signal collected by the omnidirectional microphone, and the second audio signal is an audio signal collected by the figure-eight directional microphone;
performing channel separation processing on the original audio signal to obtain a two-channel signal, wherein the two-channel signal comprises a left channel signal and a right channel signal; and
calculating, based on the two-channel signal, sound source parameters corresponding to a sound source, and rendering the original audio signal according to the sound source parameters to obtain a generated target audio signal, wherein the sound source parameters comprise at least one of a sound source orientation and a sound source size.

2. The signal generation method according to claim 1, wherein the performing channel separation processing on the original audio signal to obtain the two-channel signal comprises:
performing alignment processing on the first audio signal and the second audio signal to obtain an aligned audio signal, wherein the alignment processing comprises at least one of time alignment processing and frequency response alignment processing, the aligned audio signal comprises a third audio signal and a fourth audio signal, the third audio signal is the first audio signal after alignment processing, and the fourth audio signal is the second audio signal after alignment processing;
obtaining the left channel signal by adding the third audio signal and the fourth audio signal, and obtaining the right channel signal by subtracting a phase-inverted fourth audio signal from the third audio signal; and
determining the left channel signal and the right channel signal as the two-channel signal.

3. The signal generation method according to claim 2, wherein after the aligning the first audio signal and the second audio signal to obtain the aligned audio signal, the method further comprises:
for the third audio signal and the fourth audio signal of an initial frame, obtaining the left channel signal by adding the third audio signal and the fourth audio signal, and obtaining the right channel signal by subtracting the phase-inverted fourth audio signal from the third audio signal;
determining a signal value of the third audio signal as a first signal value, determining a signal value of the left channel signal as a second signal value, and determining a signal value of the right channel signal as a third signal value;
calculating a weighted sum of the second signal value and the third signal value to obtain a target signal value;
determining a target gain based on the first signal value and the target signal value, wherein the target gain is negatively correlated with the first signal value and positively correlated with the target signal value;
adjusting the third audio signal of a next frame with the target gain to obtain an intermediate audio signal, determining the intermediate audio signal as a new third audio signal, based on the new third audio signal and the fourth audio signal of the next frame, and returning to perform the obtaining the left channel signal by adding the third audio signal and the fourth audio signal and obtaining the right channel signal by subtracting the phase-inverted fourth audio signal from the third audio signal; and
in response to satisfying a preset separation termination condition, determining all obtained left channel signals and all obtained right channel signals as two-channel signals.

4. The signal generation method according to claim 1, wherein the calculating, based on the two-channel signal, the sound source parameters corresponding to the sound source comprises:
dividing the two-channel signal into a plurality of sub-band signals by frequency band division; and
for each sub-band signal, determining a target frequency band to which the sub-band signal belongs, and calculating sound source parameters corresponding to the sound source in the target frequency band based on the sub-band signal.

5. The signal generation method according to claim 4, wherein the calculating the sound source parameters corresponding to the sound source in the target frequency band based on the sub-band signal comprises:
calculating spatial cue parameters based on a left channel sub-signal and a right channel sub-signal in the sub-band signal, and determining the sound source parameters corresponding to the sound source in the target frequency band based on the spatial cue parameters,
wherein the left channel sub-signal and the right channel sub-signal are within a same frequency band.

6. The signal generation method according to claim 5, wherein the determining the sound source parameters corresponding to the sound source in the target frequency band based on the spatial cue parameters comprises:
in response to the spatial cue parameters comprising an interaural time difference and the target frequency band being within a preset low-frequency band, determining a sound source orientation corresponding to the target frequency band based on the interaural time difference;
in response to the spatial cue parameters comprising an interaural level difference and the target frequency band being outside the preset low-frequency band, determining a sound source orientation corresponding to the target frequency band based on the interaural level difference; and
in response to the spatial cue parameters comprising an interaural cross-correlation coefficient, determining a sound source size corresponding to the sound source in the target frequency band based on the interaural cross-correlation coefficient.

7. The signal generation method according to claim 5, wherein the calculating spatial cue parameters based on the left channel sub-signal and the right channel sub-signal in the sub-band signal comprises:
in response to the sub-band signal comprising a plurality of left channel sub-signals or a plurality of right channel sub-signals, selecting one target left channel sub-signal and one target right channel sub-signal; and
calculating the spatial cue parameters based on the target left channel sub-signal and the target right channel sub-signal.

8. An audio device, comprising:
an omnidirectional microphone;
a figure-eight directional microphone; and
a processor, wherein the omnidirectional microphone and the figure-eight directional microphone are respectively connected to the processor, and the processor is configured to execute the signal generation method according to claim 1.

9. A non-transitory computer-readable storage medium storing a program for implementing a signal generation method, wherein when the program is executed by a processor, the signal generation method according to claim 1 is implemented.

10. A computer program product comprising: a computer program, wherein when the computer program is executed by a processor, the signal generation method according to claim 1 is implemented.
